(19) United States
(12) Patent Application Publication
(10) Pub. No.: US 2026/0237836 A1
(43) Pub. Date: Aug. 13, 2026

(54) BATTERY ASSEMBLY

(71) Applicant: SK On Co., Ltd., Seoul (KR)

(72) Inventors: Seung Il KWAK, Daejeon (KR); Hae Ryong JEON, Daejeon (KR); Jung Kwan LEE, Daejeon (KR)

(21) Appl. No.: 19/533,292

(22) Filed: Feb. 9, 2026

(30) Foreign Application Priority Data
Feb. 7, 2025 (KR) 10-2025-0015706

(51) Int. Cl. H01M 50/367; H01M 10/613; H01M 10/6557; H01M 10/658; H01M 50/507; H01M 50/588; H01M 50/209

(52) U.S. Cl. CPC H01M 50/367; H01M 10/613; H01M 10/6557; H01M 10/658; H01M 50/507; H01M 50/588; H01M 50/209

(57) ABSTRACT

The present disclosure relates to a battery assembly. The battery assembly according to an embodiment of the present disclosure may comprise: a receiving case; and a plurality of battery cells, and lead tab portions electrically connected to an electrode assembly; wherein the plurality of battery cells may include a first group of battery cells including the lead tab portions protruding from one side of a cell case and a second group of battery cells including the lead tab portions protruding from the other side of the cell case; and wherein the battery assembly may further include a first exhaust passage, and a second exhaust passage.

### CROSS-REFERENCE TO RELATED PATENT APPLICATION

The present application claims priority under 35 U.S.C. § 119(a) to Korean Patent Applications No. 10-2025-0015706 filed on February 7, 2025 in the Korean Intellectual Property Office, the entire disclosures of which are incorporated by reference herein.

### BACKGROUND OF THE DISCLOSURE

### 1. Field

This disclosure relates to a battery assembly.

### 2. Description of the Related Art

The operating principle of a lithium secondary battery is an electrochemical oxidation-reduction reaction. Specifically, it generates electricity through the movement of lithium ions and is charged through the reverse process. In a lithium secondary battery, the phenomenon where lithium ions present at the anode exit and travel through the electrolyte and separator to the cathode is called discharge. The reverse process of this phenomenon is called charging.

However, recent fires and explosions occurring during the use of lithium secondary batteries have heightened societal concerns about battery safety. One of the key development challenges for lithium secondary batteries today is eliminating the instability associated with battery use, such as fires and/or explosions caused by thermal propagation and thermal runaway within the battery cell.

Therefore, there is a need for measures to ensure effective heat dissipation from the battery itself and to provide adequate space for the effective venting of gases generated inside the battery.

According to one aspect of the present disclosure, an object is to improve the stability of the battery assembly.

According to another aspect of the present disclosure, an object is to delay thermal runaway occurring inside the battery assembly.

According to another aspect of the present disclosure, an object is to enhance the lifespan of the battery assembly.

According to another aspect of the present disclosure, an object is to improve the space utilization of the battery assembly.

Meanwhile, the battery assembly according to this disclosure may be widely applied in the field of green technology, including electric vehicles, battery charging stations, energy storage systems, and other applications utilizing battery cells such as photovoltaics and wind power. Furthermore, the battery assembly according to this disclosure may be used in eco-friendly mobility, including electric vehicles and hybrid vehicles, to prevent climate change by suppressing air pollution and greenhouse gas emissions.

### SUMMARY OF THE DISCLOSURE

A battery assembly according to an embodiment of the present disclosure may comprise: a receiving case forming an internal receiving space; and a plurality of battery cells including a cell case, an electrode assembly disposed within the cell case, and lead tab portions electrically connected to the electrode assembly and protruding outward from the cell case; wherein the plurality of battery cells may include a first group of battery cells including the lead tab portions protruding from one side of the cell case and a second group of battery cells including the lead tab portions protruding from the other side of the cell case; wherein the first group of battery cells and the second group of battery cells may be alternately disposed; and wherein the battery assembly may further include a first exhaust passage formed between the receiving case and the receiving space, in a region where the lead tab portions of the first group of battery cells face the receiving case, and a second exhaust passage formed between the receiving case and the receiving space, in a region where the lead tab portions of the second group of battery cells face the receiving case.

In an embodiment, the battery assembly may further comprise cooling plates disposed on one side of first group of battery cells, between the first group of battery cells and second group of battery cells, and on the other side of the second group of battery cells, respectively.

In an embodiment, the battery assembly may further comprise a first busbar connecting the cooling plate disposed on the one side of the first group of battery cells and the lead tab portions of the first group of battery cells, and a second busbar connecting the cooling plate disposed between the first group of battery cells and the second group of battery cells and the lead tab portions of the second group of battery cells.

In an embodiment, the first busbar and the cooling plate disposed on one side of the first group of battery cells may be welded together, and the second busbar and the cooling plate disposed between the first group of battery cells and the second group of battery cells may be welded together.

In an embodiment, the battery assembly may further comprise an electrical insulating member is attached to each of the first busbar and the second busbar.

In an embodiment, the electrical insulating member may include one or a combination of mica, glass fiber, ceramic fiber.

In an embodiment, the first group of battery cells may include a first vent hole to discharge gas generated within the first group of battery cells.

In an embodiment, the battery assembly may further comprise a first thermal insulating sheet attached to the surface of the cell case of the first group of battery cells on which the first vent hole is formed.

In an embodiment, the first thermal insulating sheet further may include a first slit formed at a position corresponding to the first vent hole to allow gas discharged from the first vent hole to be discharged to the outside.

In an embodiment, the second group of battery cells may include a second vent hole to discharge gas generated within the second group of battery cells.

In an embodiment, the battery assembly according to the present disclosure may further comprise a second thermal insulating sheet attached to the surface of the cell case of the second group of battery cells on which the second vent hole is formed.

In an embodiment, the second thermal insulating sheet may further include a second slit formed at a position corresponding to the second vent hole to allow gas discharged from the second vent hole to be discharged to the outside.

In an embodiment, each of the first group of battery cells and the second group of battery cells may include the plurality of battery cells, and wherein the battery assembly may further include a first plate-shaped protective member disposed between the plurality of battery cells included in the first group of battery cells; and a second plate-shaped protective member disposed between the plurality of battery cells included in the second group of battery cells.

According to an embodiment of the present disclosure, the stability of the battery assembly may be improved.

According to another embodiment of the present disclosure, thermal runaway occurring within the battery assembly may be delayed.

According to another embodiment of the present disclosure, the lifespan of the battery assembly may be improved.

According to another embodiment of the present disclosure, the space utilization of the battery assembly may be improved.

### BRIEF DESCRIPTION OF THE DRAWINGS

FIG. 1A is an exploded view of a battery assembly according to the present disclosure.

FIG. 1B illustrates a battery assembly according to the present disclosure.

FIG. 1C illustrates another battery assembly according to the present disclosure.

FIG. 1D illustrates an exhaust passage of the battery assembly according to the present disclosure.

FIG. 2A illustrates a battery assembly according to the present disclosure.

FIG. 2B illustrates a battery assembly according to the present disclosure.

FIG. 3 illustrates a battery assembly according to the present disclosure viewed from one direction.

FIG. 4 illustrates a battery assembly according to the present disclosure.

FIGS. 5A, 5B, 6 and 7 illustrate a battery assembly according to the present disclosure as viewed from one direction.

FIG. 8 illustrates a battery assembly according to the present disclosure.

FIG. 9 illustrates a first cooling channel and a cooling plate according to the present disclosure.

FIG. 10 illustrates a second cooling channel and a cooling plate according to the present disclosure.

### DETAILED DESCRIPTION

Specific terms used herein are for convenience of description only and are not intended to limit the scope of the exemplary embodiments.

For example, expressions such as "same" and "identical" indicate not only strictly identical states but also states where tolerances exist or where differences exist to the extent that the same function is achieved.

Expressions indicating relative or absolute positioning, such as "in any direction," "along any direction," "parallel," "perpendicular," "towards the center," "concentric," or "coaxial," indicate not only strictly such positioning but also a state where there is a displacement relative to the specified direction within a tolerance or an angle or distance that achieves the same function.

The use of terms such as “first,” “second,” or “third” preceding components mentioned below is solely to avoid confusion regarding the components being referred to and is unrelated to any order, importance, or master-subordinate relationship between the components. For example, an invention including only the second component without the first component is also realizable.

Unless the context clearly indicates otherwise, singular expressions used in this specification may include plural expressions.

The following describes in detail a preferred embodiment of the present disclosure with reference to the accompanying drawings. The configuration of the device and the control method described below are intended only to illustrate the embodiment of the present disclosure and are not intended to limit the scope of the present disclosure. Reference numbers used throughout the specification denote the same components.

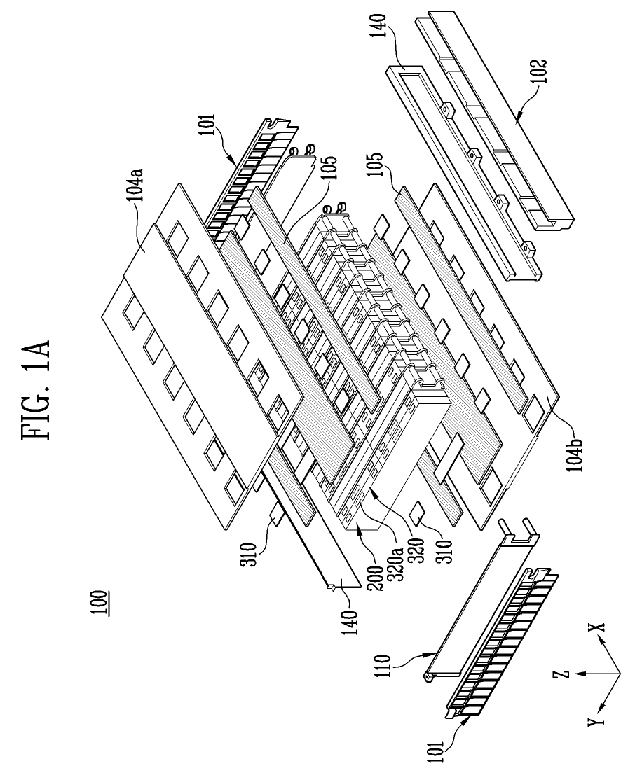

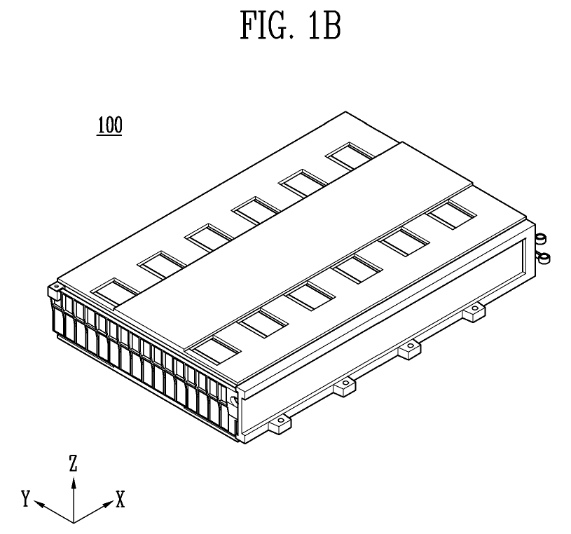

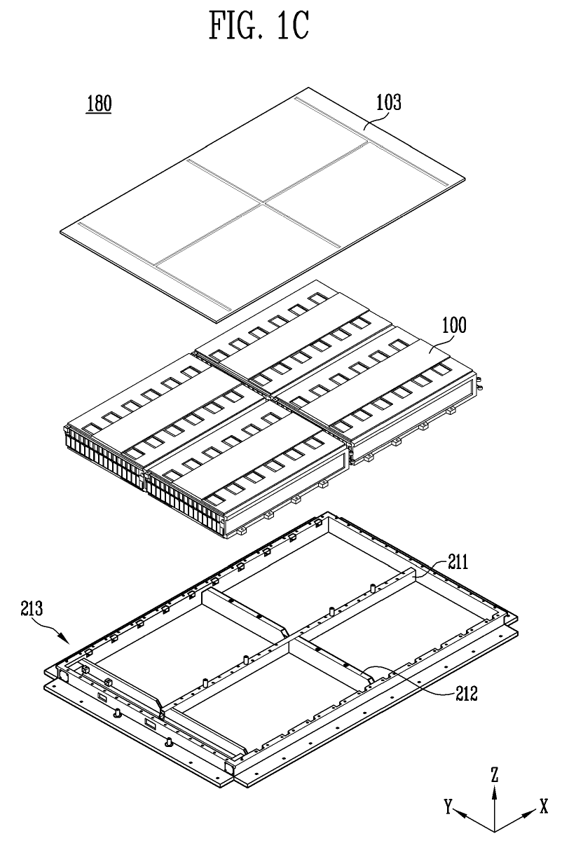

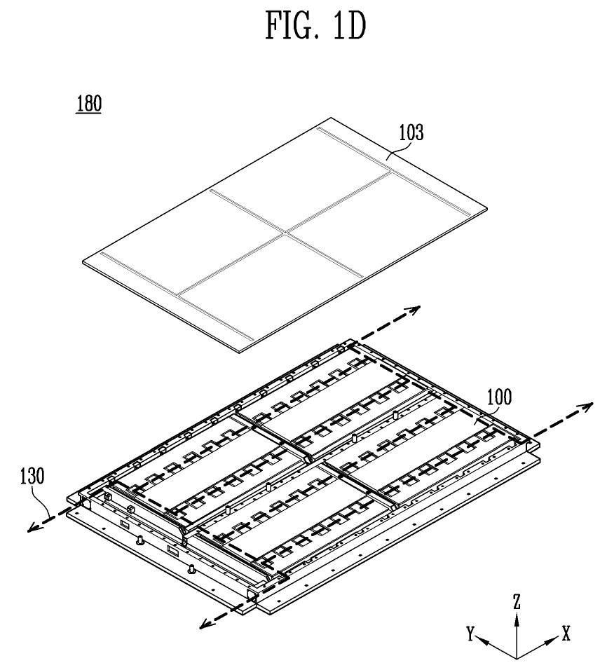

FIG. 1A is an exploded view of a battery assembly according to the present disclosure. FIG. 1B illustrates a battery assembly according to the present disclosure.

More specifically, FIG. 1A depicts an exploded view of the battery assembly 100 shown in FIG. 1B.

Referring to FIG. 1A, the battery assembly 100 according to the present disclosure may include a plurality of battery cells 200. The battery assembly 100 according to the present disclosure may represent a battery module containing a plurality of battery cells 200.

Each of the plurality of battery cells 200 according to the present disclosure may be a secondary battery capable of repeatedly performing charging and discharging. In one embodiment, each of the plurality of battery cells 200 may be a secondary battery of various types, such as a lithium-ion battery, a vanadium-ion battery, a solid-state battery, a metal-air battery, a sodium-ion battery, or an aluminum-ion battery.

Each of the plurality of battery cells 200 may be stacked and arranged in a predetermined first direction (X-axis direction) and a second direction (Y-axis direction). Each of the plurality of battery cells 200 may represent a prismatic battery cell.

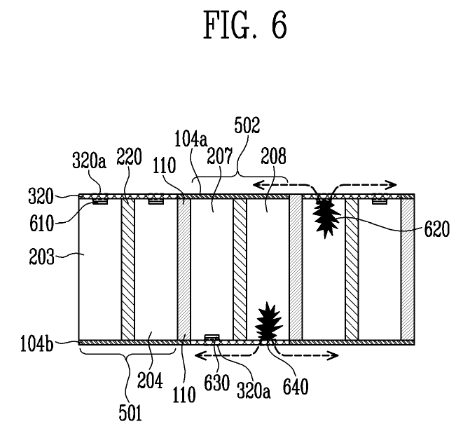

The battery assembly 100 according to this disclosure may include a receiving case comprising an upper case 104a disposed above the plurality of battery cells 200 and a lower case 104b disposed below the plurality of battery cells 200. The upper case 104a and lower case 104b may serve to form an exhaust passage for gas or heat emitted from within the plurality of battery cells 200 to be discharged through vent holes formed in each of the plurality of battery cells 200. Each of the plurality of battery cells 200 according to the present disclosure may include vent holes 610, 630, referring to FIG. 6, for discharging heat or gas from inside the plurality of battery cells 200. The upper case 104a and lower case 104b may serve to prevent gas or heat from propagating to adjacent battery cells among the plurality of battery cells 200 when gas or heat is discharged. Additionally, the upper case 104a and lower case 104b may serve to fix the position of the plurality of battery cells 200 within the battery assembly 100 or to protect the plurality of battery cells 200 from impact. According to one embodiment, the upper case 104a and lower case 104b may be formed from a material such as metal, ceramic, or polymer. For example, the metal may include steel, but the type of metal may not be limited thereto.

The receiving case according to the present disclosure may further include a side case 101. The side case 101 may be coupled to the upper case 104a and the lower case 104b.

In one embodiment, the upper case 104a and the lower case 104b may be arranged spaced apart in the height direction. The height direction may represent the third direction (Z-axis direction). The first direction (X-axis direction), the second direction (Y-axis direction), and the third direction (Z-axis direction) may represent mutually perpendicular directions.

The upper case 104a, lower case 104b, and side case 101 may be combined to form a receiving space for the plurality of battery cells 200. Plurality of battery cells 200 may be received within the receiving space.

In an embodiment, a battery assembly 100 according to present disclosure may comprise a receiving case forming an internal receiving space; and a plurality of battery cells 200 including a cell case, an electrode assembly disposed within the cell case, and lead tab portions 202a, 202b electrically connected to the electrode assembly and protruding outward from the cell case; wherein the plurality of battery cells 200 may include a first group of battery cells 501 including the lead tab portions protruding from one side of the cell case and a second group of battery cells 502 including the lead tab portions protruding from the other side of the cell case; wherein the first group of battery cells 501 and the second group of battery cells 502 may be alternately disposed; and wherein the battery assembly 100 may further include a first exhaust passage formed between the receiving case and the receiving space, in a region where the lead tab portions of the first group of battery cells 501 face the receiving case, and a second exhaust passage formed between the receiving case and the receiving space, in a region where the lead tab portions of the second group of battery cells 502 face the receiving case.

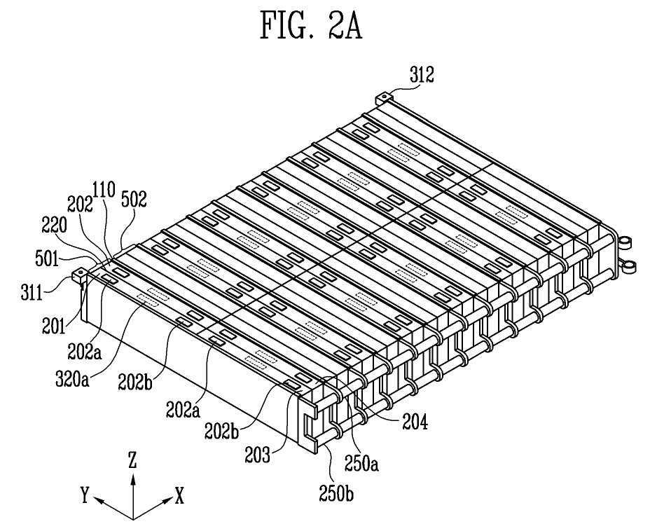

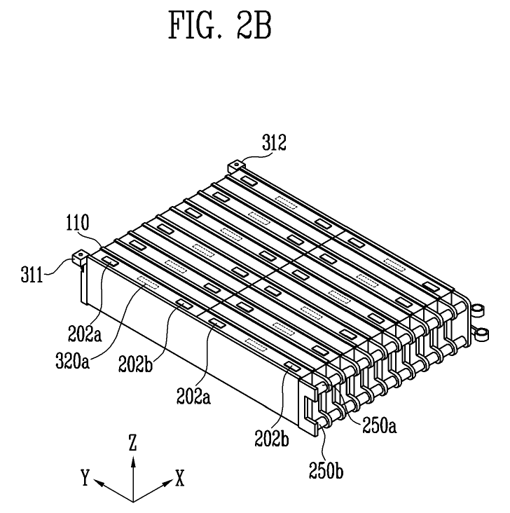

For example, each of the plurality of battery cells 200 may include a cell case containing an electrode assembly and a lead tab portion 202a, 202b, referring to FIG. 2A, electrically connected to the electrode assembly and protruding from one side of the cell case. That is, each of the plurality of battery cells 200 may include a unidirectional battery cell with lead tabs 202a, 202b protruding on one side. In one embodiment, the plurality of battery cells 200 may include a first group of battery cells 501, referring to FIG. 2A, where the lead tab portions 202a, 202b are arranged facing the upper case 104a, and a second group of battery cells 502 where the lead tab portions 202a, 202b facing the lower case 104b. In this case, the first group of battery cells 501 and the second group of battery cells 502 may be arranged alternately along a first direction (X-axis direction). In one embodiment, the first group of battery cells 501 may form a vent hole 610 in a direction facing the upper case 104a. For example, the second group of battery cells 502 may form a vent hole 630 in a direction facing the lower case 104b.

The vent hole 610 of the first group of battery cells 501 according to this disclosure may also be formed in the direction facing the lower case 104b. That is, the vent hole 610 may be formed on the surface of the cell case where the lead tab portion included in each of the first group of battery cells 501 is not formed.

The vent hole 630 of the second group of battery cells 502 according to this disclosure may also be formed in a direction facing the upper case 104a. That is, the vent hole 630 may be formed on the surface of the cell case where the lead tab portion included in each of the second group of battery cells 502 is not formed.

In one embodiment, each of the first group of battery cells 501 and each of the second group of battery cells 502 may include a plurality of battery cells arranged with a predetermined number of battery cells in each of the first direction (X-axis direction) and the second direction (Y-axis direction). For example, the predetermined number may be set to two, but the number is not limited thereto. For example, the predetermined number included in the first group of battery cells 501 and the predetermined number included in the second group of battery cells 502 may be set differently from each other.

In an embodiment, the battery assembly 100 according to the present disclosure may further comprise a first thermal insulating sheet 320 attached to the surface of the cell case of the first group of battery cells 501 on which the first vent hole is formed. In an embodiment, the battery assembly 100 according to the present disclosure may further comprise a second thermal insulating sheet 320 attached to the surface of the cell case of the second group of battery cells 502 on which the second vent hole is formed.

For example, the battery assembly 100 according to this disclosure may further include a thermal insulating sheet 320 attached to the plurality of battery cells 200. The thermal insulating sheet 320 may prevent heat transfer between the plurality of battery cells 200 and the exterior and/or heat transfer between adjacent battery cells 200 within the plurality of battery cells 200. For example, the material of the thermal insulating sheet 320 may be formed from any one or a combination of mica, sheets of flame retardant materials, extinguishing agents, and ceramic wool. However, this is an example, and the thermal insulating sheet 320 of the present disclosure may not be limited to the material of the above example as long as it is a material capable of preventing heat transfer.

The thermal insulating sheet 320 may be attached to the cell case of each of the plural battery cells 200. Specifically, the thermal insulating sheet 320 may be attached to the surface of the cell case where the lead tab portions 202a, 202b are disposed. The thermal insulating sheet 320 may be attached to the surface of each cell case of the plurality of battery cells 200 where a vent hole is formed. For example, the thermal insulating sheet 320 may be attached to the surface of the first group of battery cells 501 facing the upper case 104a among the surfaces of the cell case. For the second group of battery cells 502, the thermal insulating sheet 320 may be attached to the surface of the cell case facing the lower case 104b.

The thermal insulating sheet 320 may have a slit 320a formed therein to allow gas or heat emitted from the plural battery cells 200 to be discharged externally. The slit 320a may be formed at a position corresponding to the location where a vent hole is formed.

In an embodiment, the battery assembly 100 according to the present disclosure may further comprise a first busbar connecting the cooling plate 110 disposed on the one side of the first group of battery cells 501 and the lead tab portions of the first group of battery cells 501, and a second busbar connecting the cooling plate 110 disposed between the first group of battery cells 501 and the second group of battery cells 502 and the lead tab portions of the second group of battery cells 502.

For example, the battery assembly 100 according to this disclosure may further include a busbar 310 to connect the lead tab portions of adjacent battery cells among the plurality of battery cells 200.

In embodiment, the battery assembly 100 according to the present disclosure may further comprise an electrical insulating member 105 is attached to each of the first busbar and the second busbar.

For example, the battery assembly 100 according to the present disclosure may further include an electrical insulating member 105 disposed on the busbar 310. The electrical insulating member 105 may include insulating tape. The material of the electrical insulating member 105 may include mica, sheets of flame retardant materials, extinguishing agents, glass fiber, ceramic fiber, or any combination thereof. However, this is an example, and the electrical insulating member 105 of the present disclosure may not be limited to the material of the above example as long as it is a material capable of insulating the busbar 310. The electrical insulating member 105 may serve to insulate electrically the busbar 310 and prevent short circuits. The electrical insulating member 105 may serve to prevent heat transfer between the plurality of battery cells 200.

In an embodiment, the battery assembly 100 according to the present disclosure may further comprise: cooling plates 110 disposed on one side of first group of battery cells 501, between the first group of battery cells 501 and second group of battery cells 502, and on the other side of the second group of battery cells 502, respectively.

For example, the battery assembly 100 according to the present disclosure may further include a cooling plate 110 disposed between the first group of battery cells 501 and the second group of battery cells 502. The cooling plate 110 may be stacked and arranged along a first direction (X-axis direction).

The cooling plate 110 may be formed of a metallic material, with at least some areas electrically insulated. The cooling plate 110 may also be formed of a non-metallic material, including plastic.

The battery assembly 100 according to the present disclosure may further include, referring to FIG. 2A, a first cooling channel 250a and a second cooling channel 250b. One of the first cooling channel 250a and the second cooling channel 250b may represent a channel through which cooling medium, for example, coolant, flowing into the cooling plate 110 flows, while the other may represent a channel through which cooling medium flowing out from the cooling plate 110 flows.

The battery assembly 100 according to the present disclosure may further include a support plate 102. The support plate 102 may be referred to as a hose guide. The support plate 102 may be coupled to the side case 101. The support plate 102 may protect the first cooling channel 250a and the second cooling channel 250b.

The battery assembly 100 according to the present disclosure may further include a Cell Monitoring Unit (CMU, not shown). The CMU may measure status information including at least one of the voltage, current, or temperature of the plurality of battery cells 200 and transmit the status information to an external device.

In an embodiment, the first group of battery cells 501 include a first vent hole to discharge gas generated within the first group of battery cells 501. In an embodiment, the second group of battery cells 502 include a second vent hole to discharge gas generated within the second group of battery cells 502.

For example, the battery assembly 100 according to the present disclosure may further include an exhaust passage through which gas or heat emitted from vent holes 610, 630, referring to FIG. 6, is discharged.

The battery assembly 100 according to the present disclosure may further include a first exhaust passage through which heat or gas discharged from the vent holes 610 of the first group of battery cells 501, referring to FIG. 2A, is discharged. The first exhaust passage may be formed between the upper case 104a facing the lead tab portion of the first group of battery cells 501 and the space receiving the plurality of battery cells 200.

The battery assembly 100 according to the present disclosure may further include a second exhaust passage for discharging heat or gas discharged from the vent holes 630, referring to FIG. 2A, of the second group of battery cells 502. The second exhaust passage may be formed between the lower case 104b facing the lead tab portion of the second group of battery cells 502 and the space receiving the plurality of battery cells 200.

According to one embodiment, the upper case 104a and the lower case 104b may further include a recessed portion that is recessed along a third direction (Z-axis direction). For example, the upper case 104a may form a recessed portion that is recessed away from the receiving space along the third direction (Z-axis direction). For example, the lower case 104b may form a recessed portion that is recessed away from the receiving space along a direction (-Z-axis direction) symmetrical to the third direction (Z-axis direction).

That is, the first exhaust passage may be formed in a recess formed in the upper case 104a by being recessed in a direction away from the receiving space for the plurality of battery cells 200. The second exhaust passage may be formed in a recess formed in the lower case 104b by being recessed in a direction away from the receiving space for the plurality of battery cells 200.

In one embodiment, heat or gas generated from the first group of battery cells 501 may be discharged through the vent hole 610 into the slit 320a formed in the thermal insulation sheet 320. In one embodiment, the heat or gas discharged through the slit 320a may be discharged outside the battery assembly 100 through the first exhaust passage.

In one embodiment, heat or gas generated in the second group of battery cells 502 may be discharged through the vent hole 630 into the slit 320a formed in the thermal insulating sheet 320. In one embodiment, the heat or gas discharged through the slit may be discharged outside the battery assembly 100 through a second exhaust passage.

The battery assembly 100 according to the present disclosure may separate the exhaust passages vertically (in the third direction) by arranging the first exhaust passage in a direction toward the upper case 104a and arranging the second exhaust passage in a direction toward the lower case 104b. Through this, the battery assembly 100 may have the effect of ensuring the stability of the battery cell 200.

The battery assembly 100 according to this disclosure may directly cool the surfaces of plurality of battery cells 200 in contact with the cooling plate 110 by placing the cooling plate 110 between the first group of battery cells 501 and the second group of battery cells 502.

The battery assembly 100 according to this disclosure may not require connecting the first group of battery cells 501 and the second group of battery cells 502 via separate connecting members, thereby increasing the space utilization of the battery assembly 100. The battery assembly 100 according to this disclosure may connect the lead tab portions 202a, 202b of the first group of battery cells 501 to the lead tab portions 202a, 202b of the second group of battery cells 502 through the cooling plate 110 positioned between the first group of battery cells 501 and the second group of battery cells 502. That is, the battery assembly 100 according to the present disclosure may increase the space utilization of the battery assembly 100 while serving to cool the space between the first group of battery cells 501 and the second group of battery cells 502 via the cooling plate 110.

FIG. 1C illustrates another battery assembly according to the present disclosure.

Referring to FIG. 1C, another battery assembly 180 according to the present disclosure may represent a battery pack that receives at least one battery assembly 100 representing a battery module (e.g., the battery assembly 100 of FIGS. 1A and 1B).

Another battery assembly 180 according to the present disclosure may include a housing body 213 and a housing cover 103 that form a receiving space for receiving the battery modules (e.g., the battery assembly 100 in FIGS. 1A and 1B).

In one embodiment, the housing body 213 may form members 211, 212 that partition the receiving space. The members 211, 212 may include a first member 211 formed along a first direction (X-direction) and a second member 212 formed along a second direction (Y-direction).

In one embodiment, the housing body 213 may be connected to the housing cover 103. According to one embodiment, the housing body 213 may be connected to the housing cover 103 using an adhesive member. Alternatively, in one embodiment, the housing body 213 and the housing cover 103 may be connected to each other by the engagement of a hole formed in one and an insertion portion formed in the other. For example, the housing cover 103 may form a hole, and the housing body 213 may form an insertion portion capable of passing through the hole formed in the housing cover 103. For example, the housing body 213 may form a hole, and the housing cover 103 may form an insertion portion capable of penetrating the hole formed in the housing body 213.

FIG. 1D illustrates an exhaust passage of the battery assembly according to the present disclosure.

More specifically, referring to FIG. 1D, it is a drawing showing the battery assembly 100 placed in the receiving space formed in the housing body 213.

In one embodiment, the housing cover 103 may serve to protect the battery assembly 100 including a plurality of battery cells 200 from impact.

In one embodiment, the housing body 213 may have an exhaust port formed to allow heat or gas generated from each battery assembly 100 to be discharged to the outside.

According to one embodiment, heat or gas discharged through a first exhaust passage formed in a recess formed in the upper case 104a in a direction away from the receiving space for the plurality of battery cells 200 may be discharged to the outside of another battery assembly 180 through the exhaust port.

According to one embodiment, heat or gas discharged through a second exhaust passage formed in a recess formed in the lower case 104b in a direction away from the space receiving a plurality of battery cells 200 may be discharged outside another battery assembly 180 through the exhaust port.

Each battery assembly 100 is spatially separated from adjacent battery assemblies via the first member 211 and the second member 212, so that heat or gas generated in a battery assembly 100 may not be transferred to an adjacent battery assembly.

FIG. 2A illustrates a battery assembly according to the present disclosure.

Specifically, for ease of description, FIG. 2A is illustrated with some components of the battery assembly 100 of FIG. 1A omitted.

According to one embodiment, a plurality of battery cells 200 may be stacked along a first predetermined direction (X-axis direction) and a second direction (Y-axis direction) perpendicular to the first direction.

Each of the plurality of battery cells 200 may include a cell case including an electrode assembly and a lead tab portion 202a, 202b electrically connected to the electrode assembly and protruding from one side of the cell case.

The first lead tab portion 202a may represent a lead tab portion of a first polarity, and the second lead tab portion 202b may represent a lead tab portion of a second polarity different from the first polarity. For example, the first polarity may be the positive electrode, and the second polarity may be the negative electrode. Alternatively, the first polarity may be the negative electrode, and the second polarity may be the positive electrode. The plurality of battery cells 200 may include a first group of battery cells 501 arranged so that the lead tab portions 202a, 202b face the upper case 104a and a second group of battery cells 502 arranged so that the lead tab portions 202a, 202b face the lower case 104b. Each of the first group of battery cells 501 may have its vent hole positioned facing the upper case 104a, and each of the second group of battery cells 502 may have its vent hole positioned facing the lower case 104b. In one embodiment, a slit 320a corresponding to the vent hole formed in each of the first group of battery cells 501 may be formed on the thermal insulating sheet 320.

The first group of battery cells 501 and the second group of battery cells 502 may be alternately arranged along a predetermined first direction (X-axis direction) within the space receiving the plurality of battery cells 200.

In one embodiment, each of the first group of battery cells 501 and each of the second group of battery cells 502 may include a predetermined number of the plurality of battery cells. The first group of battery cells 501 may include battery cells arranged in a predetermined number of in both the first direction (X-axis direction) and the second direction (Y-axis direction). The second group of battery cells 502 may include battery cells arranged in a predetermined number in both the first direction (X-axis direction) and the second direction (Y-axis direction). For example, the predetermined number may be set to two, but the predetermined number is not limited thereto.

In an embodiment, each of the first group of battery cells 501 and the second group of battery cells 502 includes a plurality of battery cells 200, and wherein the battery assembly 100 may further include a first plate-shaped protective member 220 disposed between the plurality of battery cells 200 included in the first group of battery cells 501 and a second plate-shaped protective member 220 disposed between the plurality of battery cells 200 included in the second group of battery cells 502.

For example, the plate-shaped protective member 220 may be disposed between the plurality of battery cells included in the first group of battery cells 501. A plate-shaped protective member 220 may be disposed between the plurality of battery cells included in the second group of battery cells 502.

The protective member 220 may block heat propagation between the plurality of battery cells 200. The protective member 220 may be formed from a material possessing heat-resistant and insulating properties. For example, the protective member 220 may include at least some of the materials mica, mica sheet, silicate, graphite, alumina, ceramic wool or super wool, and aerogel. However, the material of the protective member 220 of the present disclosure is not limited thereto and may be formed from various materials capable of maintaining its shape and preventing thermal runaway during thermal runaway conditions between plurality of battery cells 200.

The cooling plate 110 may be stacked and arranged along a predetermined first direction (X-axis direction). The cooling plate 110 may be extended along a second direction (Y-direction).

In one embodiment, the cooling plate 110 may be disposed on one side of the first group of battery cells 501. The cooling plate 110 may contact the side of the first group of battery cells 501 and cool the side of the first group of battery cells 501.

In one embodiment, the cooling plate 110 may be positioned between the first group of battery cells 501, e.g., the opposite side of the first group of battery cells 501, and the second group of battery cells 502, e.g., one side of the second group of battery cells 502. The cooling plate 110 may be in contact with the first group of battery cells 501 and the second group of battery cells 502 to cool the first group of battery cells 501 and the second group of battery cells 502.

In one embodiment, the cooling plate 110 may be positioned on the opposite side of the second group of battery cells 502. The cooling plate 110 may be in contact with the opposite side of the second group of battery cells 502 to cool the opposite side of the second group of battery cells 502.

The battery assembly 100 according to the present disclosure may further include a first cooling channel 250a and a second cooling channel 250b. A cooling medium or cooling water may flow through the first cooling channel 250a and the second cooling channel 250b.

The first cooling channel 250a and the second cooling channel 250b may be connected to one end of the cooling plate 110. The cooling plate 110 may include an openable opened area. The cooling plate 110 can allow the cooling medium to flow into or out of the cooling plate 110 through the opened area. The cooling plate 110 may close the opened area to prevent the cooling medium from flowing in from the outside.

The first cooling channel 250a and the second cooling channel 250b may be formed extending along a predetermined first direction (X-axis direction).

The first cooling channel 250a may move the cooling medium along a predetermined first direction (X-axis direction). The first cooling channel 250a may introduce the cooling medium moving along the preset first direction (X-axis direction) into the cooling plate 110 formed extending in the second direction (Y-axis direction). At this time, the opened area of the cooling plate 110 may be in an open state.

The cooling medium, which has been heated by cooling plurality of battery cells 200 through the cooling plate 110, may flow out through the opened area of the cooling plate 110 into the second cooling channel 250b. The second cooling channel 250b may move the cooling medium along a preset first direction (X-axis direction).

In one embodiment, the battery assembly 100 according to the present disclosure may include a first terminal portion 311 and a second terminal portion 312. The first terminal portion 311 and the second terminal portion 312 may represent terminals that may be electrically connected between the battery assembly 100 and an external device. One of the first terminal portion 311 and the second terminal portion 312 may represent a positive terminal, and the other may represent a negative terminal. The positive terminal may be referred to as high voltage positive, and the negative terminal may be referred to as high voltage negative.

In one embodiment, a Cell Monitoring Unit (CMU, not shown) may be disposed between the first terminal portion 311 and the second terminal portion 312. In one embodiment, the location where the CMU (not shown) is placed may not be limited to between the first terminal portion 311 and the second terminal portion 312. The CMU may measure status information of a plurality of battery cells 200, including at least one of voltage, current, or temperature of the cells, and transmit the status information to an external device.

FIG. 2B illustrates a battery assembly according to the present disclosure.

More specifically, FIG. 2B is an illustration of an embodiment where each of the first group of battery cells 501 in FIG. 2A and each of the second group of battery cells 502 in FIG. 2A may include one battery cell each, instead of including two battery cells each in the first direction (X-axis direction) and the second direction (Y-axis direction). For example, the first group of battery cells 501 may include a plurality of battery cells arranged with a predetermined number of battery cells along each of the first direction (X-axis direction) and the second direction (Y-axis direction). The second group of battery cells 502 may include a plurality of battery cells arranged with a predetermined number of battery cells along each of the first direction (X-axis direction) and the second direction (Y-axis direction). However, this is merely one example, and the predetermined number of the plurality of battery cells included in each of the first group of battery cells 501 in FIG. 2A and the second group of battery cells 502 in FIG. 2A is not limited thereto and may be implemented with various numbers.

In one embodiment, the description for FIG. 2A applies equally to FIG. 2B.

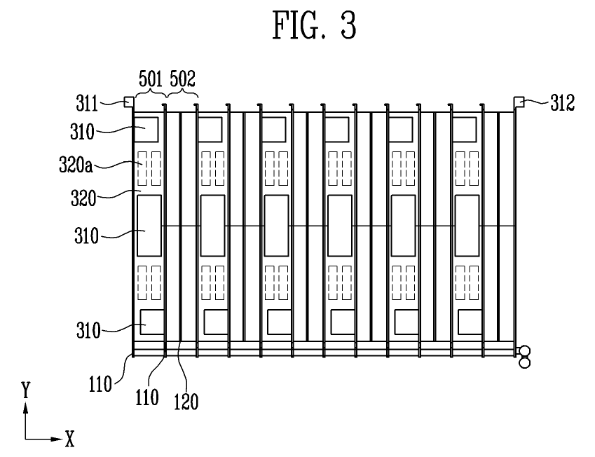

FIG. 3 illustrates a battery assembly according to the present disclosure viewed from one direction.

More specifically, FIG. 3 illustrates the battery assembly 100 of FIG. 1A as viewed along the third axis direction (Z-axis direction). For ease of explanation, some components of the battery assembly 100 have been omitted from the illustration.

A thermal insulating sheet 320 may be attached to the cell case of each of the plurality of battery cells 200.

For example, the thermal insulation sheet 320 may be attached to a surface of the cell case of the first group of battery cells 501 where a vent hole 610, referring to FIG. 6, is formed. The thermal insulation sheet 320 may not be attached to a surface of the cell case of the first group of battery cells 501 where no vent hole is formed.

For example, the second group of battery cells 502 may have a thermal insulating sheet 320 attached to the surface of the cell case where the vent hole is formed. The second group of battery cells 502 may not have a thermal insulating sheet 320 attached to the surface of the cell case where the vent hole 630, referring to FIG. 6, is not formed.

The thermal insulating sheet 320 attached to the first group of battery cells 501 may form a slit 320a to allow gas or heat emitted from the first group of battery cells 501 to be discharged to the outside. For example, the shape of the slit may not be limited to the shape shown in FIG. 3, as long as gas or heat can be discharged to the outside.

The thermal insulating sheet 320 attached to the second group of battery cells 502 may form a slit 320a to allow gas or heat emitted from the second group of battery cells 502 to be discharged to the outside.

The slit 320a may be formed at a position corresponding to the vent holes 610, 630.

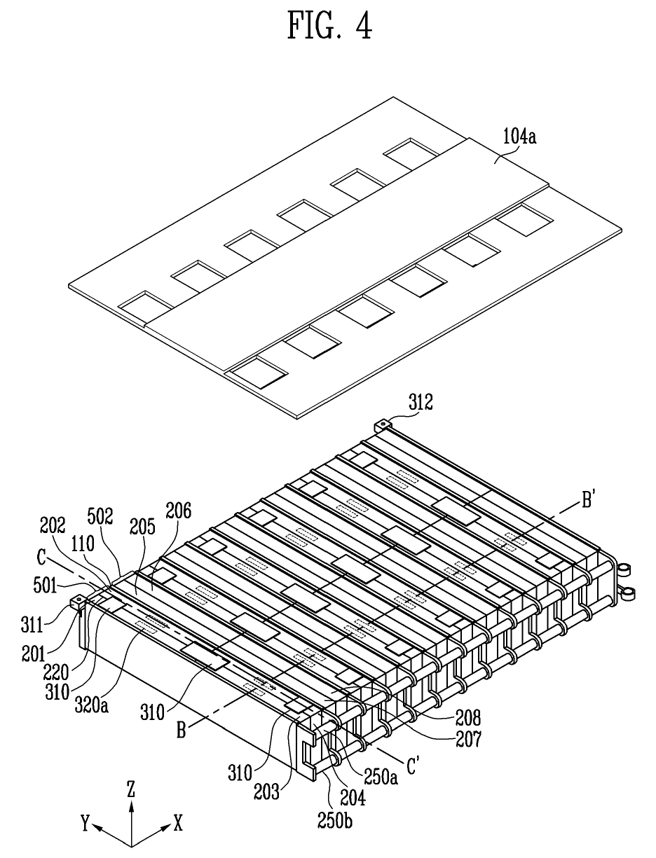

FIG. 4 illustrates a battery assembly according to the present disclosure.

More specifically, FIG. 4 is an illustration of the battery assembly 100 of FIG. 1A according to the present disclosure, with some components (e.g., electrical insulating member 105) omitted.

Referring to FIGS. 3 and 4, in one embodiment, the first group of battery cells 501 comprises a first battery cell 201, a second battery cell 202 stacked in a first direction (X-axis direction) relative to the first battery cell 201 and positioned adjacent to the first battery cell 201, a third battery cell 203 stacked in a second direction (Y-axis direction) relative to the first battery cell 201 and arranged adjacent to the first battery cell 201, and a fourth battery cell 204 stacked in the first direction (X-axis direction) relative to the third battery cell 203 and arranged adjacent to the third battery cell 203.

In one embodiment, the first lead tab portions 202a of the first polarity of the first battery cell 201 and the first lead tab portions 202a of the first polarity of the second battery cell 202 may be connected to each other via a busbar 310. That is, adjacent first lead tab portions 202a of the same first polarity may be connected in parallel via the busbar 310.

In one embodiment, the second lead tab portions 202b of the second polarity of the third battery cell 203 and the second lead tab portions 202b of the second polarity of the fourth battery cell 204 may be connected to each other via the busbar 310. That is, adjacent second lead tab portions 202b of the same second polarity may be connected in parallel via the busbar 310.

In one embodiment, the second lead tab portions 202b of the second polarity of the first battery cell 201 and the first lead tab portions 202a of the first polarity of the third battery cell 203 may be connected to each other via the busbar 310. In one embodiment, the second lead tab portions 202b of the second polarity of the second battery cell 202 and the first lead tab portions 202a of the first polarity of the fourth battery cell 204 may be connected to each other via the busbar 310. In one embodiment, the second lead tab portions 202b of the second polarity of the first battery cell 201 and the second lead tab portions 202b of the second polarity of the second battery cell 202 may be connected to each other via the busbar 310. In one embodiment, the second lead tab portions 202b of the second polarity of the second battery cell 202 and the first lead tab portions 202a of the first polarity of the fourth battery cell 204 may be connected to each other via the busbar 310.

In an embodiment, the first busbar and the cooling plate 110 disposed on one side of the first group of battery cells 501 may be welded together, and the second busbar and the cooling plate disposed between the first group of battery cells 501 and the second group of battery cells 502 may be welded together.

For example, the busbar 310 connected to the first lead tab portion 202a of the first battery cell 201 and the first lead tab portion 202a of the second battery cell 202 may be connected to a cooling plate 110 disposed on one side of the first group of battery cells 501. In this case, the busbar 310 may be welded to the cooling plate 110 arranged on one side of the first group of battery cells 501.

In one embodiment, the busbar 310 connected to the second lead tab portion 202b of the third battery cell 203 and the second lead tab portion 202b of the fourth battery cell 204 may be connected to the cooling plate 110 positioned between the first group of battery cells 501 and the second group of battery cells 502. In this case, the busbar 310 may be welded to the cooling plate 110 positioned between the first group of battery cells 501 and the second group of battery cells 502.

In one embodiment, the second group of battery cells 502 includes the fifth battery cell 205, a sixth battery cell 206 stacked in a first direction (X-axis direction) relative to the fifth battery cell 205 and positioned adjacent to the fifth battery cell 205, a seventh battery cell 207 stacked in a second direction (Y-axis direction) relative to the fifth battery cell 205 and positioned adjacent to the fifth battery cell 205, and an eighth battery cell 208 stacked in the first direction (X-axis direction) relative to the seventh battery cell 207 and positioned adjacent to the seventh battery cell 207.

In one embodiment, the first lead tab portion 202a of the first polarity of the fifth battery cell 205 and the first lead tab portion 202a of the first polarity of the sixth battery cell 206 may be connected to each other via the busbar 310.

In one embodiment, the second lead tab portion 202b of the second polarity of the seventh battery cell 207 and the second lead tab portion 202b of the second polarity of the eighth battery cell 208 may be connected to each other via the busbar 310.

In one embodiment, the second lead tab portion 202b of the second polarity of the fifth battery cell 205 and the first lead tab portion 202a of the first polarity of the seventh battery cell 207 may be connected to each other via the busbar 310. In one embodiment, the second lead tab portion 202b of the second polarity of the sixth battery cell 206 and the first lead tab portion 202a of the first polarity of the eighth battery cell 208 may be connected to each other via the busbar 310. In one embodiment, the second lead tab portion 202b of the second polarity of the fifth battery cell 205 and the second lead tab portion 202b of the second polarity of the sixth battery cell 206 may be connected to each other via the busbar 310. In one embodiment, the second lead tab portion 202b of the second polarity of the seventh battery cell 207 and the first lead tab portion 202a of the first polarity of the eighth battery cell 208 may be connected to each other via the busbar 310. In one embodiment, the busbar 310 connected to the first lead tab portion 202a of the fifth battery cell 205 and the first lead tab portion 202a of the sixth battery cell 206 may be connected to the cooling plate 110 between the first group of battery cells 501 and the second group of battery cells 502. In this case, the busbar 310 may be welded to the cooling plate 110 positioned between the first group of battery cells 501 and the second group of battery cells 502.

In one embodiment, the busbar 310 connected to the second lead tab portion 202b of the seventh battery cell 207 and the second lead tab portion 202b of the eighth battery cell 208 may be connected to a cooling plate 110 positioned on the opposite side of the second group of battery cells 502. In this case, the busbar 310 may be welded to the cooling plate 110 positioned on the opposite side of the second group of battery cells 502.

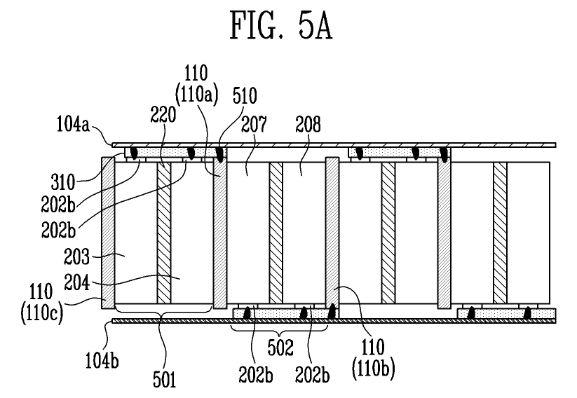

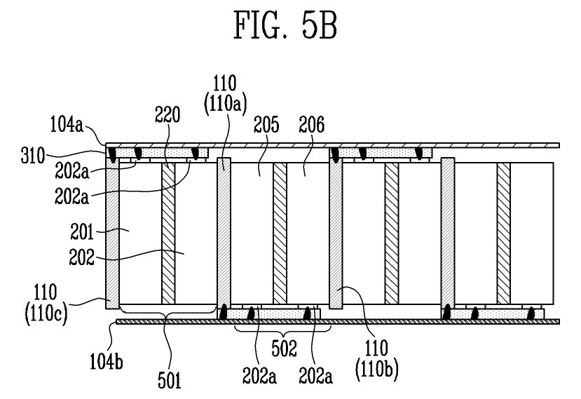

FIG. 5A illustrates a battery assembly according to the present disclosure as viewed from one direction.

More specifically, FIG. 5A shows a portion of the battery assembly 100 shown in FIG. 4 as viewed along the Y-axis.

The plurality of battery cells 200 may include a first group of battery cells 501 whose lead tab portions 202a, 202b are oriented toward the upper case 104a, and a second group of battery cells 502 whose lead tab portions202a, 202b facing the lower case 104b. The first group of battery cells 501 and the second group of battery cells 502 may be alternately arranged within the receiving space.

Protective members 220 may be disposed between the plurality of battery cells included in the first group of battery cells 501 and between the plurality of battery cells included in the second group of battery cells 502.

The lead tab portions of adjacent battery cells within the first group of battery cells 501 may be connected to each other via a busbar 310. For example, the lead tabs 202b of adjacent battery cells within the first group of battery cells 501 having the same polarity may be connected to each other via the busbar 310. The busbar 310 may be welded to each lead tab portion 202b.

The lead tab portions of adjacent battery cells in the second group of battery cells 502 may be connected to each other via the busbar 310. For example, the lead tab portions 202b of adjacent battery cells in the second group of battery cells 502 having the same polarity may be connected to each other via the busbar 310. The busbar 310 may be welded to each lead tab portion 202b.

The cooling plate 110 may be connected to the busbar 310. For example, the cooling plate 110 may be welded to the busbar 310.

The cooling plate 110 may be provided in a plurality. For example, the plurality of cooling plates 110 may include a first cooling plate 110a, a second cooling plate 110b, and a third cooling plate 110c.

One end of the first cooling plate 110a may be connected to the lead tab portion 202b of an adjacent battery cell within the first group of battery cells 501 having the same polarity via the busbar 310. The other end of the first cooling plate 110a may not be connected to the lead tab portions of the second group of battery cells 502 adjacent to the first group of battery cells 501. For example, one end of the first cooling plate 110a may be connected to the lead tab portions 202b of the third battery cell 203 and the fourth battery cell 204, respectively, via the busbar 310. The other end of the first cooling plate 110a may not be connected to the lead tab portions 202b of the seventh battery cell 207 and the eighth battery cell 208, respectively, included in the second group of battery cells 502.

One end of the second cooling plate 110b may be connected to the lead tab portions 202b of adjacent battery cells within the second group of battery cells 502 having the same polarity via the busbar 310. For example, one end of the second cooling plate 110b may be connected to the lead tab portions 202b of the seventh battery cell 207 and the eighth battery cell 208, respectively, via the busbar 310. The other end of the second cooling plate 110b may not be connected to the lead tab portions of the first group of battery cells 501 adjacent to the second group of battery cells 502.

FIG. 5B illustrates a battery assembly according to the present disclosure as viewed from one direction.

More specifically, FIG. 5B shows a portion of the battery assembly 100 shown in FIG. 4 as viewed along the -Y axis. The -Y axis may represent an axis symmetrical to the Y-axis about the origin.

The cooling plates 110 may be provided in a plurality. For example, the plurality of cooling plates 110 may include a first cooling plate 110a, a second cooling plate 110b, and a third cooling plate 110c.

One end of the first cooling plate 110a may be connected to the lead tab portion 202a of an adjacent battery cell having the same polarity among the first group of battery cells 501 via the busbar 310. The other end of the first cooling plate 110a may not be connected to the lead tab portion of the second group of battery cells 502 adjacent to the first group of battery cells 501. For example, one end of the first cooling plate 110a may be connected to the lead tab portions 202a of the first battery cell 201 and the second battery cell 202, respectively, via a busbar 310. The other end of the first cooling plate 110a may not be connected to the lead tab portions 202a of the fifth battery cell 205 and the sixth battery cell 206 included in the second group of battery cells 502.

One end of the second cooling plate 110b may be connected to the lead tab portions 202a of adjacent battery cells within the second group of battery cells 502 having the same polarity via the busbar 310. For example, one end of the second cooling plate 110b may be connected to the lead tab portions 202a of the fifth battery cell 205 and the sixth battery cell 206, respectively, via the busbar 310. The other end of the second cooling plate 110bmay not be connected to the lead tab portions of the first group of battery cells 501 adjacent to the second group of battery cells 502.

FIG. 6 illustrates a battery assembly according to the present disclosure as viewed from one direction.

Each of the plurality of battery cells included in the first group of battery cells 501 may include a vent hole 610. The first group of battery cells 501 may have a thermal insulating sheet 320 with a slit 320a formed thereon attached thereto. The slit 320a may be formed at a position corresponding to the vent hole 610.

Gas or heat 620 discharged from the vent hole 610 of the first group of battery cells 501 may be discharged into the first exhaust passage through the vent hole 610 and the slit 320a. The first exhaust passage may be formed in the space between the receiving space for the plurality of battery cells 200 and the upper case 104a. Alternatively, the first exhaust passage may represent the space between the receiving space for the plurality of battery cells 200 and the upper case 104a. The first exhaust passage may be connected to the exterior of the plurality of battery cells 200.

Each of the plurality of battery cells included in the second group of battery cells 502 may include a vent hole 630. The second group of battery cells 502 may have a thermal insulating sheet 320 with a slit 320a formed therein attached thereto. Gas or heat 640 discharged from the vent hole 630 may be discharged into the second exhaust passage through the vent hole 630 and the slit 320a. The second exhaust passage may be formed in the space between the receiving space for the plurality of battery cells 200 and the lower case 104b. Alternatively, the second exhaust passage may represent the space between the receiving space for the plurality of battery cells 200 and the lower case 104b. The second exhaust passage may be connected to the exterior of the plurality of battery cells 200.

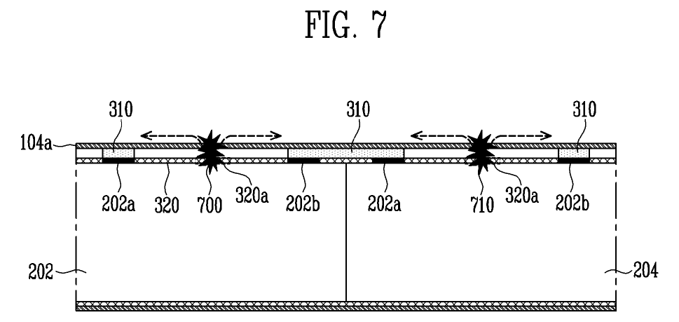

FIG. 7 illustrates a battery assembly according to the present disclosure as viewed from one direction.

More specifically, FIG. 7 shows a portion of the X-Y plane cut along the C-C' section shown in FIG. 4.

The busbar 310 may be connected to each lead tab portions 202a, 202b of the first group of battery cells 501. The second lead tab portion 202b of the second battery cell 202 included in the first group of battery cells 501 and the first lead tab portion 202a of the fourth battery cell 204 may be connected to each other via the busbar 310.

Gas or heat 700 discharged from the vent hole 610 of the battery cell 501 in the first group of battery cells may be discharged into the first exhaust passage through the vent hole 610 and the slit 320a.

The first exhaust passage may be formed in the space between the receiving space for the plurality of battery cells 200 and the upper case 104a. The first exhaust passage may be formed recessed in the upper case 104a in a direction away from the receiving space. Alternatively, the first exhaust passage may represent the space between the receiving space for the plurality of battery cells 200 and the upper case 104a.

A busbar 310 may be connected to each lead tab portion 202a, 202b of the second group of battery cells 502. Although not shown, the second exhaust passage may be formed in the space between the receiving space for the plurality of battery cells 200 and the lower case 104b. The second exhaust passage may be formed recessed in the lower case 104b in a direction away from the receiving space. Alternatively, the second exhaust passage may represent the space between the receiving space for the plurality of battery cells 200 and the lower case 104b.

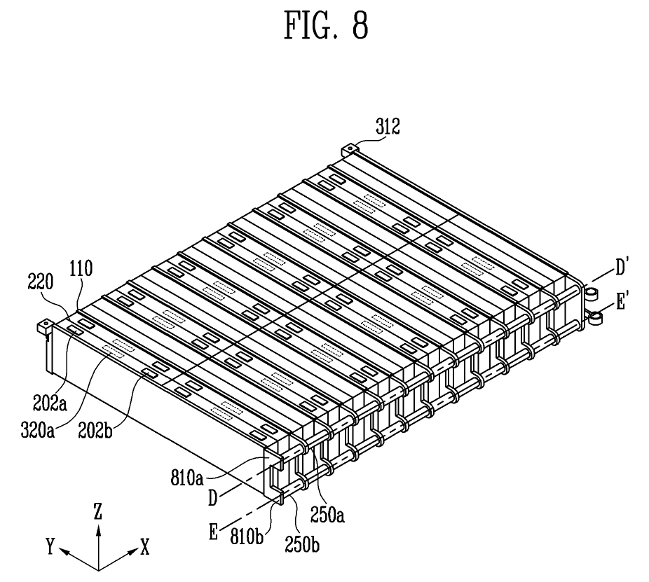

FIG. 8 illustrates a battery assembly according to the present disclosure.

Specifically, for ease of description, FIG. 8 is illustrated with some components of the battery assembly 100 shown in FIG. 1A omitted.

The battery assembly 100 according to the present disclosure may include a first cooling channel 250a and a second cooling channel 250b connected to the cooling plate 110.

The cooling plate 110 may be formed in a plate shape. The cooling plate 110 may include fastening members 810a, 810b formed extending from a second direction (Y-axis direction).

The first cooling channel 250a may include an insertion hole into which the fastening member 810a may be inserted. The fastening member 810a may form a protruding shape to be inserted into the insertion hole.

The second cooling passage 250b may include an insertion hole into which the fastening member 810b may be inserted. The fastening member 810b may form a protruding shape to be inserted into the insertion hole.

The first cooling channel 250a and the second cooling channel 250b may be channels through which a cooling medium or cooling water flows.

The first cooling channel 250a may represent a channel through which cooling medium flows to be introduced into the cooling plate 110 for cooling a plurality of battery cells 200. The second cooling channel 250b may represent a channel through which the cooling medium flows after its temperature has increased due to cooling the plurality of battery cells 200 from the cooling plate 110. The first cooling channel 250a may be connected to an inlet that supplies the cooling medium. The second cooling channel 250b may be connected to an outlet discharging the cooling medium.

Alternatively, the second cooling channel 250b may represent a channel through which cooling medium flows into the cooling plate 110 to cool the plurality of battery cells 200. The first cooling channel 250a may represent a channel through which the cooling medium flows after its temperature has increased due to cooling plurality of battery cells 200 discharged from the cooling plate 110. Alternatively, the first cooling channel 250a may be connected to an outlet discharging the cooling medium. The second cooling channel 250b may be connected to an inlet that supplies the cooling medium.

For convenience of explanation, the first cooling channel 250a is described as representing a channel through which cooling medium flowing into the cooling plate 110 flows, and the second cooling channel 250b is described as representing a channel through which cooling medium flowing out from the cooling plate 110 flows.

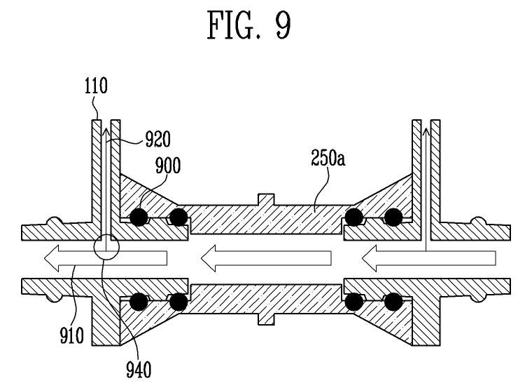

FIG. 9 illustrates a first cooling channel and a cooling plate according to the present disclosure.

More specifically, FIG. 9 shows an X-Y plane cutting the battery assembly 100 shown in FIG. 8 at D-D'.

In one embodiment, the cooling plate 110 may be connected to the first cooling channel 250a. In one embodiment, the cooling plate 110 may be connected to the first cooling channel 250a via an O-ring 900.

A cooling medium or cooling water 910 may flow through the first cooling channel 250a. The cooling plate 110 may include an openable opened area 940. The cooling plate 110 may allow the cooling medium 910 to flow into the interior of the cooling plate 110 through the opened area 940.

The cooling plate 110 may close the opened area 940 once the cooling medium 910 flows into the interior of the cooling plate 110 and a specified amount of the cooling medium is introduced.

The cooling plate 110 may cool the battery cell 200 in contact with the cooling plate 110 through the cooling medium 910 flowing into the interior of the cooling plate 110.

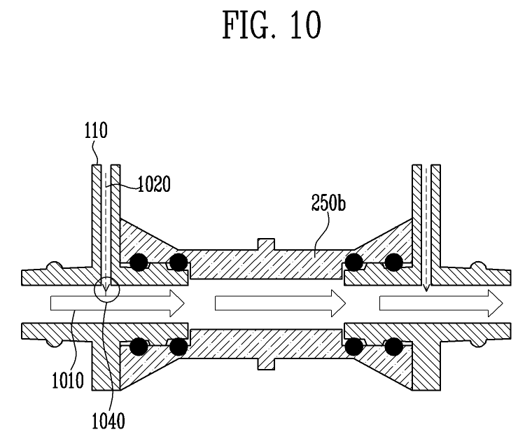

FIG. 10 illustrates a second cooling channel and a cooling plate according to the present disclosure.

More specifically, FIG. 10 shows an X-Y plane cutting the battery assembly 100 shown in FIG. 8 along E-E'.

In one embodiment, the cooling plate 110 may be connected to the second cooling channel 250b. In one embodiment, the cooling plate 110 may be connected to the second cooling channel 250b via an O-ring.

A cooling medium 1010, whose temperature has increased after cooling a plurality of battery cells, may flow through the second cooling channel 250b. The cooling plate 110 may include an openable opened area 1040. The cooling plate 110 may discharge the heated cooling medium 1010 from the cooling plate 110 to the second cooling channel 250b through the opened area 1040.

The present disclosure may be practiced in various forms of modification and is not limited to the above-described embodiments. Therefore, if a modified embodiment includes the components of the claims of the present disclosure, it should be considered within the scope of the present disclosure.

What is claimed is:

1. A battery assembly comprising:
a receiving case forming an internal receiving space; and
a plurality of battery cells including a cell case, an electrode assembly disposed within the cell case, and lead tab portions electrically connected to the electrode assembly and protruding outward from the cell case;
wherein the plurality of battery cells include a first group of battery cells including the lead tab portions protruding from one side of the cell case and a second group of battery cells including the lead tab portions protruding from the other side of the cell case;
wherein the first group of battery cells and the second group of battery cells are alternately disposed in the receiving space; and
wherein the battery assembly further includes a first exhaust passage formed between the receiving case and the receiving space, in a region where the lead tab portions of the first group of battery cells face the receiving case, and a second exhaust passage formed between the receiving case and the receiving space, in a region where the lead tab portions of the second group of battery cells face the receiving case.

2. The battery assembly according to claim 1, further comprising:
cooling plates disposed on one side of first group of battery cells, between the first group of battery cells and second group of battery cells, and on the other side of the second group of battery cells, respectively.

3. The battery assembly according to claim 2, further comprising:
a first busbar connecting the cooling plate disposed on the one side of the first group of battery cells and the lead tab portions of the first group of battery cells; and
a second busbar connecting the cooling plate disposed between the first group of battery cells and the second group of battery cells and the lead tab portions of the second group of battery cells.

4. The battery assembly according to claim 3, wherein the first busbar and the cooling plate disposed on one side of the first group of battery cells are welded together, and the second busbar and the cooling plate disposed between the first group of battery cells and the second group of battery cells are welded together.

5. The battery assembly according to claim 3, further comprising:
an electrical insulating member is attached to each of the first busbar and the second busbar.

6. The battery assembly according to claim 5, wherein the electrical insulating member includes one or a combination of mica, glass fiber, ceramic fiber.

7. The battery assembly according to claim 1, wherein the first group of battery cells includes a first vent hole to discharge gas generated within the first group of battery cells.

8. The battery assembly according to claim 7, further comprising:
a first thermal insulating sheet attached to the surface of the cell case of the first group of battery cells on which the first vent hole is formed.

9. The battery assembly according to claim 8, wherein the first thermal insulating sheet further includes a first slit formed at a position corresponding to the first vent hole to allow gas discharged from the first vent hole to be discharged to the outside.

10. The battery assembly according to claim 1, wherein the second group of battery cells includes a second vent hole to discharge gas generated within the second group of battery cells.

11. The battery assembly according to claim 10, further comprising:
a second thermal insulating sheet attached to the surface of the cell case of the second group of battery cells on which the second vent hole is formed.

12. The battery assembly according to claim 11, wherein the second thermal insulating sheet further includes a second slit formed at a position corresponding to the second vent hole to allow gas discharged from the second vent hole to be discharged to the outside.

13. The battery assembly according to claim 1, wherein each of the first group of battery cells and the second group of battery cells includes the plurality of battery cells, and
wherein the battery assembly further includes a first plate-shaped protective member disposed between the plurality of battery cells included in the first group of battery cells; and a second plate-shaped protective member disposed between the plurality of battery cells included in the second group of battery cells.
